(19) United States
(12) Patent Application Publication
(10) Pub. No.: US 2026/0360184 A1
(43) Pub. Date: Nov. 12, 2026

(54) ARTIFICIAL-INTELLIGENCE-BASED BEHAVIOR MONITORING METHOD, PROGRAM AND APPARATUS

(71) Applicant: EDINT INC., Daejeon (KR)

(72) Inventors: Dongil WON, Seoul (KR); Jihun LEE, Gwacheon (KR); Hohwan SHIN, Hwaseong (KR)

(21) Appl. No.: 19/129,692

(22) PCT Filed: Dec. 19, 2022
(86) PCT No.: PCT/KR2022/020721

§ 371 Date: May 14, 2025

(30) Foreign Application Priority Data
Nov. 15, 2022 (KR) 10-2022-0153012

(51) Int. Cl. G06V 40/20; G06V 10/75; G06V 10/82; G06V 20/52; G06V 40/16

(52) U.S. Cl. CPC G06V 40/20; G06V 10/751; G06V 10/82; G06V 20/52; G06V 40/166; G06V 40/171

(57) ABSTRACT

There are disclosed an artificial intelligence-based face recognition method, program and device according to one embodiment of the present disclosure. The method may include: synchronizing first image data captured from a first direction based on the face of a person who is a subject of behavior monitoring and second image data captured from a second direction different from the first direction; generating an analysis result for at least one detection item included in each of a plurality of detection targets based on each of the synchronized first image data and second image data by using a pre-trained neural network model; and estimating a behavior of the person by combining a first analysis result based on the synchronized first image data and a second analysis result based on the synchronized second image data.

### TECHNICAL FIELD

The present disclosure relates to data analysis technology, and more particularly, to a method and device for performing estimation and monitoring based on complex determination results for a behavior of a person obtained based on artificial intelligence.

### BACKGROUND ART

In an environment constructed according to a specific purpose, there are situations where it is necessary to check the behavior taken by a person and analyze the results of the behavior taken by the person. For example, in an educational environment where a test is taken, it is necessary to monitor the behaviors taken by a test taker during the test. In particular, unlike in an offline test, it is difficult to effectively check the behaviors of the test taker and a surrounding environment in an online test. Therefore, in an environment where an online test is taken, it is more important for an administrator to check whether there is any cheating behavior by accurately analyzing the behaviors taken by each test taker in real time.

As can be seen from the examples described above, it is not easy to effectively monitor a behavior of a person and surroundings in an environment constructed online. Although there are conventional technologies that analyze a specific behavior of a person by using a detection device such as a camera, most of them analyze a specific behavior of a person based only on fragmentary information obtained in a specific situation. However, when analysis is performed based only on fragmentary information as described above, it is difficult to accurately interpret whether a person is taking a behavior, requiring determination, in a specific environment. For example, when a cheating behavior is detected by analyzing only a front image of a person in an online test environment, the limited information available from the front image increases the probability that a behavior will not be determined to be a cheating behavior even when it is suspected as a cheating behavior or the probability that a behavior will be erroneously determined to be a cheating behavior even when it is not a cheating behavior.

### DISCLOSURE

### Technical Problem

The present disclosure has been conceived in response to the above-described background art, and an object of the present disclosure is to provide a method and device capable of comprehensively determining and accurately monitoring what behavior a person takes within a specific environment based on various detection results.

However, the objects to be achieved in the present disclosure are not limited to the object mentioned above, and other objects not mentioned may be clearly understood based on the following description.

### Technical Solution

According to one embodiment of the present disclosure for achieving the above-described object, there is disclosed an artificial intelligence-based behavior monitoring method that is performed by a computing device. The artificial intelligence-based behavior monitoring method may include: synchronizing first image data captured from a first direction based on the face of a person who is a subject of behavior monitoring and second image data captured from a second direction different from the first direction; generating an analysis result for at least one detection item included in each of a plurality of detection targets based on each of the synchronized first image data and second image data by using a pre-trained neural network model; and estimating a behavior of the person by combining a first analysis result based on the synchronized first image data and a second analysis result based on the synchronized second image data.

Alternatively, the detection item may be state information identified based on a subclass of the detection target. Furthermore, the state information may be changeable according to the behavior of the person.

Alternatively, the plurality of detection targets may include one or more of a body part of the person, a thing excluding the person, a sound of an object associated with the behavior of the person, and a time of an object associated with the behavior of the person.

Alternatively, the neural network model may include: a first model for tracking a gaze of the person based on image data captured in the first direction; and a second model for estimating a pose of the person based on image data captured in the second direction.

Alternatively, generating the analysis result for at least one detection item included in each of the plurality of detection targets based on each of the synchronized first image data and second image data by using the pre-trained neural network model may include: when feature points for the face of the person and feature points for a body of the person extracted by inputting the synchronized second image data to the second model are misaligned with each other by a predetermined angle or more, correcting the feature points extracted from the synchronized second image data based on the coordinate system of feature points extracted by inputting the synchronized first image data to the first model.

Alternatively, determining the determination condition for estimating the behavior of the person by combining the first analysis result based on the synchronized first image data and the second analysis result based on the synchronized second image data may include: determining whether a first expected behavior according to the first analysis result and a second expected behavior according to the second analysis result match each other; estimating the reliability of at least one of the first and second analysis results; and estimating the behavior of the person by combining the first analysis result and the second analysis result based on the determined presence or absence of a match and the estimated reliability.

Alternatively, estimating the behavior of the person by combining the first analysis result and the second analysis result based on the determined presence or absence of the match and the estimated reliability may include: when the first expected behavior and the second expected behavior match each other, estimating the matched expected behavior as the behavior of the person.

Alternatively, estimating the behavior of the person by combining the first analysis result and the second analysis result based on the determined presence or absence of the match and the estimated reliability may include: when the first expected behavior and the second expected behavior do not match each other and the reliability of the second analysis result is lower than a threshold, estimating the first expected behavior as the behavior of the person.

Alternatively, estimating the behavior of the person by combining the first analysis result and the second analysis result based on the determined presence or absence of the match and the estimated reliability may include: when the first expected behavior and the second expected behavior do not match each other and the reliability of the second analysis result is equal to or higher than a threshold, estimating the behavior of the person based on a determination condition derived by combining the first and second analysis results.

Alternatively, the first direction may a direction from the front of the face, and the second direction may a direction from a side of the face.

According to one embodiment of the present disclosure for achieving the above-described object, there is disclosed a computer program that is stored in a computer-readable storage medium. The computer program causes operations for monitoring behavior based on artificial intelligence to be performed when executed by at least one processor. In this case, the operations include operations of: synchronizing first image data captured from a first direction based on the face of a person who is a subject of behavior monitoring and second image data captured from a second direction different from the first direction; generating an analysis result for at least one detection item included in each of a plurality of detection targets based on each of the synchronized first image data and second image data by using a pre-trained neural network model; and estimating a behavior of the person by combining a first analysis result based on the synchronized first image data and a second analysis result based on the synchronized second image data.

According to one embodiment of the present disclosure for achieving the above-described object, there is disclosed a computing device for monitoring behavior based on artificial intelligence. The computing device may include: a processor including at least one core; memory including program codes executable by the processor; and a network unit for obtaining image data. In this case, the processor synchronizes first image data captured from a first direction based on the face of a person who is a subject of behavior monitoring and second image data captured from a second direction different from the first direction, generates an analysis result for at least one detection item included in each of a plurality of detection targets based on each of the synchronized first image data and second image data by using a pre-trained neural network model, and estimates a behavior of the person by combining a first analysis result based on the synchronized first image data and a second analysis result based on the synchronized second image data.

### Advantageous Effects

The present disclosure may provide the method and device capable of comprehensively determining and accurately monitoring what behavior a person takes within a specific environment based on various detection results.

### DESCRIPTION OF DRAWINGS

FIG. 1 is a block diagram of a computing device according to one embodiment of the present disclosure;

FIG. 2 is a block diagram showing a process of performing behavior monitoring of a computing device according to one embodiment of the present disclosure;

FIG. 3 is a conceptual diagram in which a per-behavior estimation process of a computing device according to one embodiment of the present disclosure is subdivided;

FIG. 4 is a conceptual diagram showing a computational process for the feature correction of a neural network model according to one embodiment of the present disclosure;

FIG. 5 is a flowchart showing an artificial intelligence-based behavior monitoring method according to one embodiment of the present disclosure; and

FIG. 6 is a flowchart showing a method of monitoring behavior in an online test environment according to one embodiment of the present disclosure.

### MODE FOR INVENTION

Embodiments of the present disclosure will be described in detail below with reference to the accompanying drawings so that those having ordinary skill in the art of the present disclosure (hereinafter, those skilled in the art) can easily implement the present disclosure. The embodiments presented in the present disclosure are provided to enable those skilled in the art to use or practice the content of the present disclosure. Accordingly, various modifications to embodiments of the present disclosure will be apparent to those skilled in the art. That is, the present disclosure may be implemented in various different forms and is not limited to the following embodiments.

The same or similar reference numerals denote the same or similar components throughout the specification of the present disclosure. Additionally, in order to clearly describe the present disclosure, reference numerals for parts that are not related to the description of the present disclosure may be omitted in the drawings.

The term “or” used herein is intended not to mean an exclusive “or” but to mean an inclusive “or.” That is, unless otherwise specified herein or the meaning is not clear from the context, the clause “X uses A or B” should be understood to mean one of the natural inclusive substitutions. For example, unless otherwise specified herein or the meaning is not clear from the context, the clause “X uses A or B” may be interpreted as any one of a case where X uses A, a case where X uses B, and a case where X uses both A and B.

The term “and/or” used herein should be understood to refer to and include all possible combinations of one or more of listed related concepts.

The terms “include” and/or “including” used herein should be understood to mean that specific features and/or components are present. However, the terms “include” and/or “including” should be understood as not excluding the presence or addition of one or more other features, one or more other components, and/or combinations thereof.

Unless otherwise specified herein or unless the context clearly indicates a singular form, the singular form should generally be construed to include “one or more.”

The term “N-th (N is a natural number)” used herein may be understood as an expression used to distinguish the components of the present disclosure according to a predetermined criterion such as a functional perspective, a structural perspective, or the convenience of description. For example, in the present disclosure, components performing different functional roles may be distinguished as a first component or a second component. However, components that are substantially the same within the technical spirit of the present disclosure but should be distinguished for the convenience of description may also be distinguished as a first component or a second component.

The term “obtaining” used herein may be understood to mean not only receiving data over a wired/wireless communication network connecting with an external device or a system, but also generating data in an on-device form.

Meanwhile, the term “module” or “unit” used herein may be understood as a term referring to an independent functional unit processing computing resources, such as a computer-related entity, firmware, software or part thereof, hardware or part thereof, or a combination of software and hardware. In this case, the “module” or “unit” may be a unit composed of a single component, or may be a unit expressed as a combination or set of multiple components. For example, in the narrow sense, the term “module” or “unit” may refer to a hardware component or set of components of a computing device, an application program performing a specific function of software, a procedure implemented through the execution of software, a set of instructions for the execution of a program, or the like. Additionally, in the broad sense, the term “module” or “unit” may refer to a computing device itself constituting part of a system, an application running on the computing device, or the like. However, the above-described concepts are only examples, and the concept of “module” or “unit” may be defined in various manners within a range understandable to those skilled in the art based on the content of the present disclosure.

The term “model” used herein may be understood as a system implemented using mathematical concepts and language to solve a specific problem, a set of software units intended to solve a specific problem, or an abstract model for a process intended to solve a specific problem. For example, a neural network “model” may refer to an overall system implemented as a neural network that is provided with problem-solving capabilities through training. In this case, the neural network may be provided with problem-solving capabilities by optimizing parameters connecting nodes or neurons through training. The neural network “model” may include a single neural network, or a neural network set in which multiple neural networks are combined together.

The term “image” used herein may refer to multidimensional data composed of discrete image elements. In other words, “image” may be understood as a term that refers to a digital representation of an object that can be viewed by a human eye. For example, “image” may refer to multidimensional data composed of elements corresponding to pixels in a two-dimensional image. “Image” may refer to multidimensional data composed of elements corresponding to voxels in a three-dimensional image.

The foregoing descriptions of the terms are intended to help to understand the present disclosure. Accordingly, it should be noted that unless the above-described terms are explicitly described as limiting the content of the present disclosure, the terms in the content of the present disclosure are not used in the sense of limiting the technical spirit of the present disclosure.

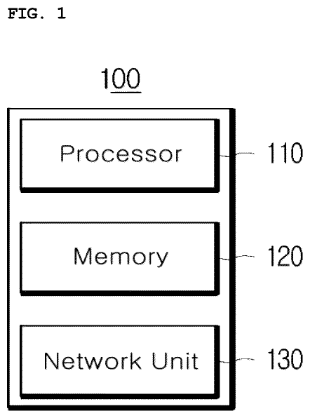

FIG. 1 is a block diagram of a computing device according to one embodiment of the present disclosure.

A computing device 100 according to one embodiment of the present disclosure may be a hardware device or part of a hardware device that performs the comprehensive processing and computation of data, or may be a software-based computing environment connected over a communication network. For example, the computing device 100 may be a server that is a main agent for performing an intensive data processing function and sharing resources, or may be a client that shares resources through interaction with a server. Alternatively, the computing device 100 may be a cloud system in which multiple servers and clients comprehensively process data while interacting with each other. Since the above description is only one example related to the type of computing device 100, the type of computing device 100 may be configured in various manners within a range understandable to those skilled in the art based on the content of the present disclosure.

Referring to FIG. 1, the computing device 100 according to one embodiment of the present disclosure may include a processor 110, memory 120, and a network unit 130. However, FIG. 1 is only an example, and the computing device 100 may further include other components for implementing a computing environment. Furthermore, only some of the disclosed components may be included in the computing device 100.

The processor 110 according to one embodiment of the present disclosure may be understood as a constituent unit including hardware and/or software for performing computing operations. For example, the processor 110 may read a computer program and perform data processing for machine learning. The processor 110 may process computational processes such as the processing of input data for machine learning, the extraction of features for machine learning, and the computation of errors based on backpropagation. The processor 110 for performing such data processing may include a central processing unit (CPU), a general purpose graphics processing unit (GPGPU), a tensor processing unit (TPU), an application specific integrated circuit (ASIC), and a field programmable gate array (FPGA). Since the types of processor 110 described above are only examples, the type of processor 110 may be configured in various manners within a range understandable to those skilled in the art based on the content of the present disclosure.

The processor 110 may perform the preprocessing of a plurality of pieces of image data obtained for behavior monitoring. Even when the same object or environment is captured, the information represented in image data may vary depending on the capture time, the capture direction, and/or the like. Accordingly, the processor 110 utilizing a plurality of pieces of image data for behavior monitoring may perform synchronization in order to ensure the accuracy of complex analysis and determination for the plurality of pieces of image data. In this case, the synchronization may be understood as a task of adjusting or matching the capture times of a plurality of pieces of image data based on an object, which is a detection target, in the plurality of pieces of image data in which the same environment is captured. For example, unlike image data captured from the front of the face of a person, image data captured from a side of the face of a person may not include information about the face depending on the movement of the head of the person. Accordingly, the processor 110 may perform preprocessing to synchronize the capture times of the two pieces of data so that the image data captured from the front and the image data captured from the side can be used complementarily. Through this synchronization preprocessing, the processor 110 may stably combine the analysis results of the two pieces of image data, and may also improve the accuracy of behavior estimation results for behavior monitoring.

The processor 110 may generate an analysis result for each of a plurality of detection targets based on image data for a person, who is a subject of behavior monitoring, by using a pre-trained neural network model. In this case, the detection target may be understood as a component of image data that serves as a criterion for estimating a behavior of the person. Furthermore, the analysis result for the detection target may be information indicating what type of behavior the person takes based on the detection target present in the image data. More specifically, the detection target may be any one of a body part of the person, a thing other than the person, a sound of an object associated with a behavior of the person, and a time of an object associated with the behavior of the person. The object related to a behavior of the person may be a body part of the person or a thing that can change due to the influence of the behavior of the person. Furthermore, the analysis result for the detection target may be information about the behavior performed by the person based on the body part of the person, a thing, a sound of an object, or a time of an object present in the image data. That is, the processor 110 may generate an analysis result for each of the detection targets present in the image data as basic data for detecting a specific behavior of a person performed under a specific environment for behavior monitoring by inputting the image data to a pre-trained neural network model.

The processor 110 may estimate a specific behavior of a person for behavior monitoring based on analysis results for each of a plurality of pieces of image data that are obtained based on the neural network model described above. The processor 110 may interpret the behavior taken by a person who is a subject of behavior monitoring by combining the analysis results of the neural network model for a plurality of pieces of image data for which synchronization has been completed. In this case, the processor 110 may use a ruleset to estimate a behavior of the person based on the combined analysis results. The ruleset may be a set of behavior classes that are detection candidates in a specific environment for behavior monitoring and a determination condition for each of the behavior classes. Furthermore, the ruleset may be generated, changed, or modified by an administrator who has constructed the specific environment for behavior monitoring. That is, the processor 110 may estimate the behavior of the person present in the image data by comprehensively determining the analysis results for the individual detection targets present in the image data based on the ruleset that can be customized to fit the specific environment for behavior monitoring. For example, assuming that the environment for behavior monitoring is an environment for an online test, the ruleset generated by a client of a test supervisor may be a set of a cheating behavior for a test and/or an abnormal behavior that is not a cheating behavior but may be suspected as a cheating behavior and determination conditions for the cheating behavior and/or the abnormal behavior. The processor 110 may combine the analysis results of the neural network model for the front image data and the side image data, and may identify the combination results that match the determination conditions included in the above-described ruleset. In this case, the combination of the analysis results may be understood as a computational process of comparing the behavior expected from the analysis results of the front mage data and the behavior expected from the analysis results of the side image data and combining the analysis results into one ground behavior based on the comparison results. In addition, the processor 110 may determine whether a test taker has performed a cheating behavior or abnormal behavior included in the ruleset under a situation, determined by observational data based on the combination results that match the determination conditions.

In this manner, the processor 110 may derive information about a ground behavior for determining what behavior a person takes based on the behavior expected from each of the plurality of pieces of image data, and may monitor a specific behavior of the person based on the ruleset generated in accordance with a specific environment. Accordingly, the processor 110 may perform precise, accurate, and stable detection and analysis compared to detection and analysis based on single image data.

The memory 120 according to one embodiment of the present disclosure may be understood as a constituent unit including hardware and/or software for storing and managing data that is processed in the computing device 100. That is, the memory 120 may store any type of data generated or determined by the processor 110 and any type of data received by the network unit 130. For example, the memory 120 may include at least one type of storage medium of a flash memory type, hard disk type, multimedia card micro type, and card type memory, random access memory (RAM), static random access memory (SRAM), read-only memory (ROM), electrically erasable programmable read-only memory (EEPROM), programmable read-only memory (PROM), magnetic memory, a magnetic disk, and an optical disk. Furthermore, the memory 120 may include a database system that controls and manages data in a predetermined system. Since the types of memory 120 described above are only examples, the type of memory 120 may be configured in various manners within a range understandable to those skilled in the art based on the content of the present disclosure.

The memory 120 may structure, organize and manage the data required for the processor 110 to perform operations, combinations of data, and the program codes executable by the processor 110. For example, the memory 120 may store the image data received via the network unit 130 to be described later. The memory 120 may store the program codes that operate the processor 110 to train a deep learning model, the program codes that operate the processor 110 to estimate a behavior of a person by using a trained deep learning model, various types of data that are generated as program codes are executed, etc.

The network unit 130 according to one embodiment of the present disclosure may be understood as a constituent unit that transmits and receives data via any type of known wired/wireless communication system. For example, the network unit 130 may perform data transmission and reception by using a wired/wireless communication system such as a local area network (LAN), a wideband code division multiple access (WCDMA) network, a long term evolution (LTE) network, the wireless broadband Internet (WiBro), a 5th generation mobile communication (5G) network, an ultra-wideband wireless communication network, a ZigBee network, a radio frequency (RF) communication network, a wireless LAN, a wireless fidelity network, a near field communication (NFC) network, or a Bluetooth network. Since the above-described communication systems are only examples, the wired/wireless communication system for the data transmission and reception of the network unit 130 may be applied in various manners other than the above-described examples.

The network unit 130 may receive data required for the processor 110 to perform computation through wired/wireless communication with any system, any server, any client, or the like. Furthermore, the network unit 130 may transmit the data, generated through the computation of the processor 110, through the wired/wireless communication with any system, any server, any client, or the like. For example, the network unit 130 may receive image data of a person, who is a subject of behavior monitoring, through wired/wireless communication with a detection device such as a camera, a client equipped with a detection device, or the like. Furthermore, the network unit 130 may receive user input through a user interface implemented in the detection device or the client equipped with the detection device. The network unit 130 may transmit various types of data generated through the computation of the processor 110 based on the image data through wired/wireless communication with the detection device, the client equipped with a detection device, or the like.

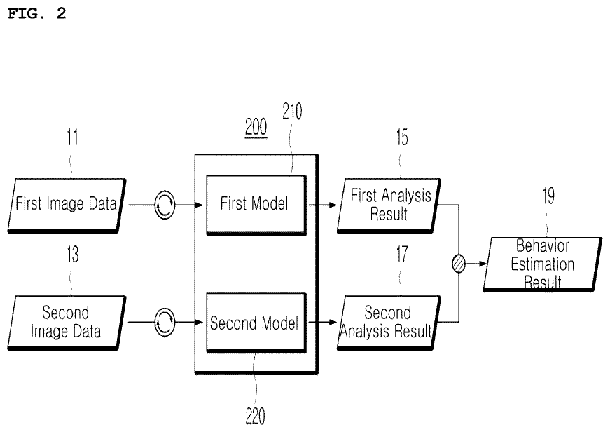

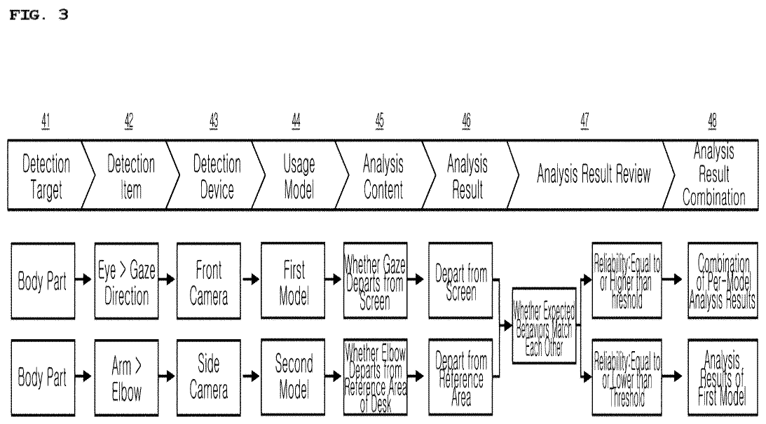

FIG. 2 is a block diagram showing a process of performing behavior monitoring of a computing device according to one embodiment of the present disclosure. Furthermore, FIG. 3 is a conceptual diagram in which a per-behavior estimation process of a computing device according to one embodiment of the present disclosure is subdivided.

Referring to FIG. 2, the computing device 100 according to one embodiment of the present disclosure may perform the preprocessing of a plurality of pieces of image data for a person who is a subject of behavior monitoring. In this case, the image data may include first image data 11 captured in a first direction based on the face of the person who is the subject of behavior monitoring and second image data 13 captured in a second direction different from the first direction. That is, the computing device 100 may synchronize the first image data 11 captured in the first direction based on the face and the second image data 13 captured in the second direction different from the first direction.

For example, the first image data 11 and the second image data 13 may be images captured by a camera that is installed in a space for an online test. In this case, a detection device such as a camera may be a component of a client possessed by a test taker. The detection device may be installed in the test space to individually capture the face of the test taker from the front and a side. When an online test begins, the detection device included in the client of the test taker may generate the first image data 11 in which the face of the test taker is captured from the front and the second image data 13 in which the face of the test taker is captured from a side. The computing device 100 may obtain the first image data 11 and the second image data 13, generated by the client of the test taker, through wired/wireless communication with the client of the test taker. Furthermore, the computing device 100 may synchronize the first image data 11 and the second image data 13 in order to utilize both the first image data 11 and the second image data 13 for the purpose of analysis by the neural network model 200 to be described later. Since the second image data 13 is captured based on the side of the person, there may be cases where the face of the person is not appropriately represented depending on the movement of the person or the capture angle. Therefore, in order to accurately and stably perform analysis on the face included in the body part of the person that is a detection target, the computing device 100 may synchronize the first image data 11 and the second image data 13.

The computing device 100 may input the synchronized first and second image data to the neural network model 200. In this case, the neural network model 200 may include a first model 210 configured to track a gaze of a person based on image data captured in the first direction and a second model 220 configured to estimate a pose of a person based on image data captured in the second direction. That is, the computing device 100 may input the synchronized first image data to the first model 210 optimized for a task that is gaze tracking. Furthermore, the computing device 100 may input the synchronized second image data to the second model 220 optimized for a task that is pose estimation.

For example, the first model 210 may receive image data captured from the front based on the face of a person, and may track a gaze of the person in the image data. More specifically, the first model 210 may extract the face area of the person from the image data captured from the person and generate a crop image. The first model 210 may extract features based on the crop image and recognize the eye of the person. Furthermore, the first model 210 may analyze the movement and change of the pupil included in the recognized eye and track the gaze of the person. For this gaze tracking, the first model 210 may include a neural network optimized for image processing. In addition, the first model 210 may be trained based on not only supervised learning but also semi-supervised learning, unsupervised learning, self-supervised learning, etc.

The second model 220 may receive image data captured from a side based on the face of a person and detect a pose taken by the person in the image data. More specifically, the second model 220 may receive image data, may classify a body part and a background based on a plurality of feature points for identifying the pose of the person, and may generate a mask for the body part. Furthermore, the second model 220 may analyze the mask for the body part to estimate the pose that is taken by the person. For this pose estimation, the second model 220 may include a neural network optimized for image processing. Furthermore, the second model 220 may be trained based on not only supervised learning but also semi-supervised learning, unsupervised learning, self-supervised learning, etc.

The computing device 100 may generate analysis results for at least one detection item included in each of the plurality of detection targets via the neural network model 200 to which the plurality of pieces of synchronized image data is input. The computing device 100 may generate per-detection item analysis results through the first model 210 to which the synchronized first image data is input. The computing device 100 may generate per-detection item analysis results through the second model 220 to which the synchronized second image data is input. In this case, the detection item of the first model 210 and the detection item of the second model 220 may be the same as or different from each other.

For example, when the detection target is a body part of a person, the subclasses of the detection target may be divided into the face, the arms, etc. The face may be divided into the eyes, the nose, the mouth, and the ears. Furthermore, the arms may be divided into the hands, the palms, the fingers, etc. The detection item is state information that can be detected based on each of the subclasses of the detection target, such as a gaze direction, the presence or absence of an utterance, a hand position, and a palm direction. In other words, the detection item may represent a specific state or appearance that can appear when the subclass of the detection target moves or changes according to the behavior of a person.

In other words, the computing device 100 may input synchronized first image data to the pre-trained first model 210 to generate a first analysis result 15 including analysis results for various detection items. Furthermore, the computing device 100 may input synchronized second image data to the pre-trained second model 220 to generate a second analysis result 17 including analysis results for various detection items. In this case, each of the first and second analysis results 15 and 17 may include analysis results that match each detection item such as a gaze direction, the presence or absence of an utterance, a hand position, or a palm direction.

For example, assuming that the environment for behavior monitoring is an environment for an online test, the analysis result matching a gaze direction may indicate the result of detecting whether a test taker is gazing at a display for checking test paper. The analysis result matching the presence or absence of an utterance may indicate the result of detecting whether the shape of the mouth of the test taker has changed. The analysis result matching a hand position may indicate the result of detecting whether the left or right hand of the test taker is moving within a reference space determined according to the arrangement of the body of the test taker and a desk. The analysis results matching the above-described detection items may be included in each of the first and second analysis results 15 and 17. In this manner, the computing device 100 may individually generate analysis results for at least one detection item included in each of the plurality of detection targets by using the first and second models 210 and 220. Through this process, the computing device 100 may obtain various types of information to be used in the computation for behavior estimation to be described later from the image data captured at various angles.

Referring to FIG. 2, the computing device 100 may combine a plurality of analysis results, generated via the neural network model 200, in order to estimate a behavior of a person who is a subject of monitoring. The computing device 100 may combine the first analysis result 15 generated via the first model 210 and the second analysis result 17 generated via the second model 220 in order to generate the behavior estimation result 19. In this case, the computing device 100 may utilize a first expected behavior inferred from the first analysis result 15 and a second expected behavior inferred from the second analysis result 19 in order to combine the first and second analysis results 15 and 17. Furthermore, the computing device 100 may utilize the reliability of the first analysis result 15 and the reliability of the second analysis result 17 in order to combine the first and second analysis results 15 and 17.

More specifically, the computing device 100 may estimate the first expected behavior according to the first analysis result 15 and the second expected behavior according to the second analysis result 17 based on a predetermined ruleset. The computing device 100 may determine whether the estimated first expected behavior and the estimated second expected behavior match each other. Furthermore, the computing device 100 may estimate at least one of the reliability of the first analysis result 15 and the reliability of the second analysis result 17 by analyzing at least one of the first model 210 and the second model 220. The computing device 100 may generate ground information, corresponding to a determination condition for estimating a behavior by combining the first and second analysis results 15 and 17, based on the determination of whether the first and second expected behaviors match each other and the reliability of at least one of the first and second analysis results 15 and 17.

For example, referring to FIG. 3, when the first analysis result 15 is derived as “a test taker is gazing outside a display for checking test paper” based on a detection item that is a gaze direction, the computing device 100 may estimate the first expected behavior as a cheating behavior from the first analysis result 15 based on the predetermined ruleset. That is, the computing device 100 may determine that the first analysis result 15 matches the determination condition of a cheating behavior included in the predetermined ruleset and estimate the first expected behavior as a cheating behavior. When the second analysis result 17 is derived as “the lower end of an elbow of a test taker departs from a reference area” based on a detection item that is a body part, the computing device 100 may estimate the second expected behavior as abnormal behavior from the second analysis result 17 based on the predetermined ruleset. That is, the computing device 100 may determine that the second analysis result 17 matches the determination condition of an abnormal behavior included in the predetermined ruleset and estimate the second expected behavior as an abnormal behavior. When the first and second expected behaviors do not match each other in this manner, the computing device 100 may combine the first and second analysis results 15 and 17 as “the lower end of the elbow of the test taker departs from the reference area and the test taker is gazing outside the display.” In this case, the result of the combination described above may vary depending on the reliability of the first analysis result 15 and the reliability of the second analysis result 17. For example, when the reliability of the second analysis result 17 is lower than a threshold, the computing device 100 can derive the first analysis result “the test taker is gazing outside the display” as the result of the combination. When the reliability of the second analysis result 17 is equal to or higher than the threshold, the computing device 100 may derive the above-described result “the lower end of the elbow of the test taker departs from the reference area and the test taker is gazing outside the display” as the result of the combination. However, the computing device 100 may derive the accuracy of the result of the combination based on the weighted sum of the accuracy of the first analysis result 15 and the accuracy of the second analysis result 17 so that the first analysis result 15 can be more significantly reflected in final behavior estimation. Furthermore, the computing device 100 may derive the correlation between the result of the combination and a cheating or abnormal behavior based on the weighted sum of the correlation between the first analysis result 15 and the cheating or abnormal behavior and the correlation between the second analysis result 17 and the cheating or abnormal behavior. In this case, the correlation may be understood as a quantitative indicator indicating the extent to which a specific analysis result influences the determination of a cheating or abnormal behavior. That is, the content of the result of the combination is derived as “the lower end of the elbow of the test taker departs from the reference area and the test taker is gazing outside the display” described above, whereas the result of the weighted sum described above may be reflected in the accuracy or correlation for the result of the combination. Furthermore, the accuracy or correlation for the result of the combination may be reflected in a computational process for the final behavior estimation of the computing device 100. In this manner, the computing device 100 may combine the analysis results of data captured in different directions (or at different angles) in a complementary manner and monitor behavior, thereby increasing the accuracy of behavior estimation.

The computing device 100 may use a ruleset predetermined to fit a specific environment for behavior monitoring in order to derive the behavior estimation result 19. More specifically, the computing device 100 may identify a per-behavior class determination condition included in the predetermined ruleset that matches the result of the combination of the first and second analysis results 15 and 17. In this case, when the first and second analysis results 15 and 17 are combined via a weighted sum, the computing device 100 may filter the per-behavior class determination conditions included in the predetermined ruleset by reflecting therein the accuracy or correlation for the result of the combination of the first and second analysis results 15 and 17, thereby deriving the behavior estimation result 19 corresponding to the behavior class. The computing device 100 may estimate a behavior of a person that needs to be detected for behavior monitoring under a specific environment based on a behavior class corresponding to an identified determination condition.

For example, assuming that the environment for behavior monitoring is an environment for an online test, the computing device 100 may identify the determination condition of the first behavior class regarding a cheating behavior or the determination condition of the second behavior class regarding an abnormal behavior that matches the result of the combination of the first and second analysis results 15 and 17 by screening the predetermined ruleset. The computing device 100 may derive the first behavior class regarding a cheating behavior or second behavior class regarding an abnormal behavior, corresponding to the identified determination condition, as the behavior estimation result 19.

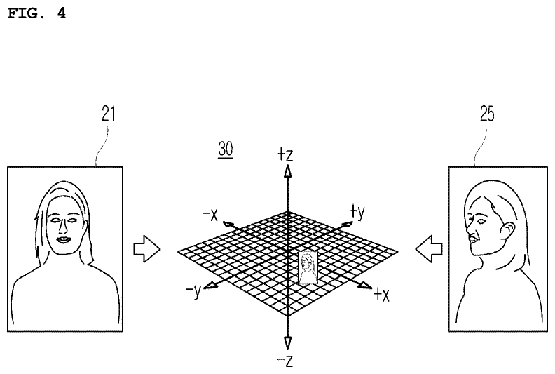

FIG. 4 is a conceptual diagram showing a computational process for the feature correction of a neural network model according to one embodiment of the present disclosure.

Referring to FIG. 4, the computing device 100 according to one embodiment of the present disclosure may extract feature points for each of the face and body of a person by inputting synchronized first image data 21 to the first model. The computing device 100 may extract feature points for each of the face and body of the person by inputting synchronized second image data 25 to the second model. In this case, when the feature points for the face of the person and the feature points for the body of the person extracted from the synchronized second image data 25 are misaligned with each other by a predetermined angle or more, the computing device 100 may correct the feature points extracted from the synchronized second image data 25 based on the feature points extracted from the synchronized first image data 21.

For example, it is assumed that the synchronized first image data 21 is an image captured in a direction from the front of a person, and the synchronized second image data 25 is an image captured in the direction from a side of the person. Unlike in the first image data 21 in which the capture of the face is less influenced by the movement of the person, the capture of the face in the second image data 25 is highly influenced by the movement of the person. That is, when the person moves, as in the case where the face of the person rotates by more than 45 degrees relative to the body, the second model may not appropriately extract feature points for the face of the person from the second image data 25 and performs unstable analysis. Accordingly, when the feature points for the face extracted from the second image data 25 and the feature points for the body are misaligned by more than 45 degrees, the computing device 100 may adjust the coordinates of the feature points extracted from the second image data 25 based on the coordinate system 30 of the feature points extracted from the first image data 21, which is less influenced by the movement of a person. The computing device 100 may generate the output of the second model by using the feature points of the second image data 25 whose coordinates have been adjusted. That is, the second model may generate per-each detection item analysis results by using the feature points corrected based on the feature points extracted by the first model. Through this correction, the computing device 100 may secure the stability of data analysis.

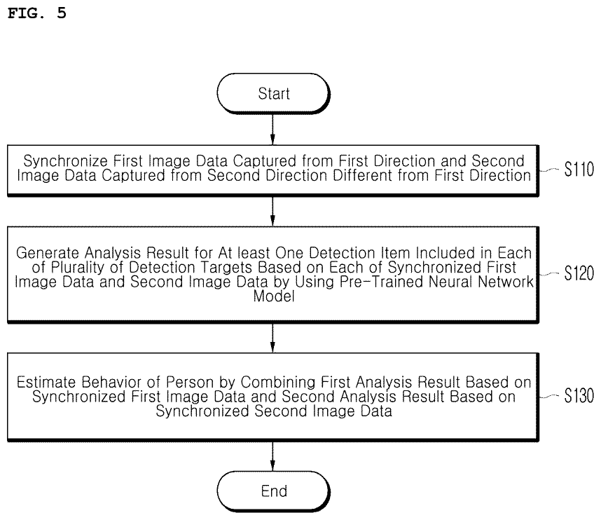

FIG. 5 is a flowchart showing an artificial intelligence-based behavior monitoring method according to one embodiment of the present disclosure.

Referring to FIG. 5, the computing device 100 according to one embodiment of the present disclosure may synchronize first image data captured in a first direction based on the face of a person, who is a subject of behavior monitoring, and second image data captured in a second direction different from the first direction in step S110. For example, the computing device 100 may synchronize the first image data generated via a camera installed in front of the face of a person and the second image data generated via a camera installed on a side of the face of the person. In this case, the synchronization of the first image data and the second image data may be understood as a task of aligning the time points, at which the face of the person was captured, to match each other. The computing device 100 may effectively utilize the first image data and the second image data together as data for behavior estimation through synchronization.

The computing device 100 may generate an analysis result for at least one detection item included in each of the plurality of detection targets based on the first image data and the second image data synchronized via step S110 by using a pre-trained neural network model in step S120. In this case, the plurality of detection targets may include one or more of a body part of the person, a thing other than the person, a sound of an object associated with a behavior of the person, and a time of an object associated with the behavior of the person. Furthermore, the detection item is state information that is identified based on a subclass of the detection target, and may be state information that can change according to a behavior of a person. For example, the computing device 100 may generate an analysis result for at least one detection item included in at least one of a body part, an object, a sound of an object, and a time of an object based on the image data captured from the front of the face. The computing device 100 may generate an analysis result for at least one detection item included in at least one of a body part, an object, a sound of an object, and a time of an object by inputting second image data synchronized with the first image data to the second model that estimates a pose of the person based on the image data captured from the side of the face. The detection target and detection item that serve as analysis criteria for the first model may be the same as or different from the detection target and detection item that serve as analysis criteria for the second model.

The computing device 100 may estimate a behavior of the person by combining the first analysis result generated via step S120 and the second analysis result generated via step S120 in step S130. More specifically, the computing device 100 may determine whether a first expected behavior according to the first analysis result and a second expected behavior according to the second analysis result match each other. In this case, the expected behavior may correspond to an estimated behavior included in a ruleset pre-determined according to the behavior monitoring environment. Furthermore, the computing device 100 may estimate the reliability of at least one of the first and second analysis results. The computing device 100 may estimate a behavior of the person by combining the first and second analysis results based on the determined presence or absence of a match and the estimated reliability. For example, when the first and second expected behaviors match each other, the computing device 100 may estimate the matched expected behavior as a behavior of the person. When the first and second expected behaviors do not match each other and the reliability of the second analysis result is lower than a threshold, the computing device 100 may estimate the first expected behavior as a behavior of the person. When the first and second expected behaviors do not match each other and the reliability of the second analysis result is equal to or higher than a threshold, the computing device 100 may estimate a behavior of the person based on the determination condition derived by combining the first and second analysis results. In this case, a behavior of the person estimated based on each of the expected behaviors or the determination condition may be determined based on a ruleset determined in advance according to the behavior monitoring environment. In this case, the threshold may be a value that is determined in advance by an administrator for behavior monitoring.

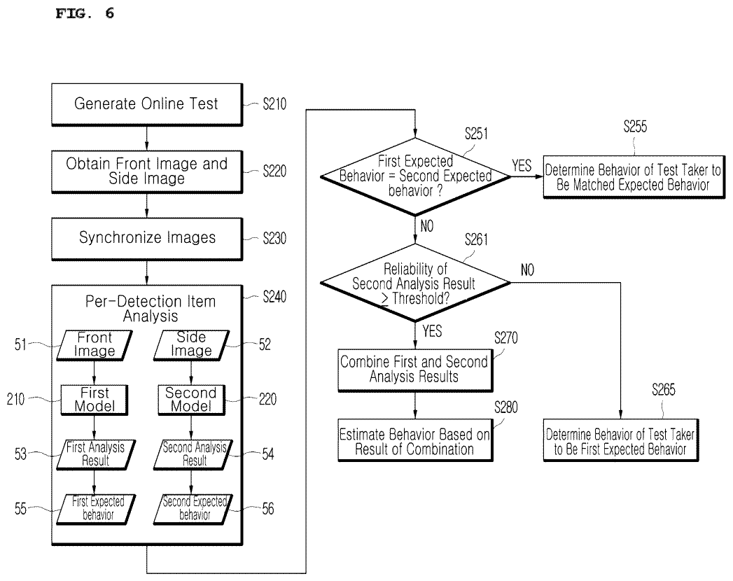

FIG. 6 is a flowchart showing a method of monitoring behavior in an online test environment according to one embodiment of the present disclosure.

Referring to FIG. 6, the computing device 100 according to one embodiment of the present disclosure may generate an online test based on a user request input via an online test host client in step S210. In this case, environmental conditions for an online test, a ruleset for the monitoring of the behavior of a test taker, and/or the like may be determined by reflecting therein the user request input via the host client. For example, the computing device 100 may determine the cycle at which observational data is obtained, a ruleset including definitions and determination conditions for a cheating behavior or an abnormal behavior, and/or the like based on a user request input via the host client. The ruleset may be dynamically updated in a process in which the computing device 100 repeatedly performs behavior estimation after having been generated in response to a user request.

Once the online test has been generated in step S210, the computing device 100 may obtain an image obtained by capturing a test taker in accordance with a predetermined cycle in step S220. For example, the computing device 100 may obtain a front image and side image of the face of the test taker at intervals of 100 ms to 1 s through wired/wireless communication with a detection device installed in a test space. In this case, the detection device may be a component equipped in the client of the test taker, or may be a component of the computing device 100. Furthermore, the cycle at which the observational data is obtained may be determined in advance in accordance with the environmental conditions of the online test via step S210.

The computing device 100 may synchronize the front image and the side image with each other in step S230. Even when the front and side images are images generated by capturing the same subject (i.e., the test taker), the computing device 100 may perform a preprocessing task to match the capture times of the front and side images to each other based on the face of the test taker for stable analysis.

The computing device 100 may perform per-detection item analysis by inputting the synchronized front image 51 and the synchronized side image 52 to the neural network model in step S240. The computing device 100 may generate a first analysis result 53 for the detection item to which the first model 210 is matched by inputting the synchronized front image 51 to the pre-trained first model 210. The computing device 100 may generate a second analysis result 54 for the detection item to which the second model 220 is matched by inputting the synchronized side image 52 to the pre-trained second model 220. The computing device 100 may estimate a first expected behavior 55 based on the first analysis result 53. The first expected behavior 55 may be understood as a behavior that is determined when a cheating or abnormal behavior is expected based on the first analysis result 53. The computing device 100 may estimate a second expected behavior 56 based on the second analysis result 54. The second expected behavior 56 may be understood as a behavior that is determined when a cheating or abnormal behavior is expected based on the second analysis result 54.

The computing device 100 may determine whether the first and second expected behaviors 55 and 56 match each other in step S251. When the first and second expected behaviors 55 and 56 match each other, the computing device 100 may determine the behavior of the test taker to be the matched expected behavior in step S255. When the first and second expected behaviors 55 and 56 do not match each other, the computing device 100 may determine whether the reliability of the second analysis result 54 is equal to or higher than a threshold in step S261. When the reliability of the second analysis result 54 is lower than the threshold, the computing device 100 may determine the behavior of the test taker to be the first expected behavior 55 in step S265. When the reliability of the second analysis result 54 is equal to or higher than a threshold, the computing device 100 may combine the first analysis result 53 and the second analysis result 54 together in step S270. Then, the computing device 100 may estimate the behavior of the test taker based on the result of the combination in step S280.

For example, when the first and second expected behaviors 55 and 56 are cheating or abnormal behaviors and thus match each other, the computing device 100 may determine the behavior of the test taker to be the matched behavior. When the first expected behavior 55 is a cheating behavior, the second expected behavior 56 is an abnormal behavior and thus they do not match each other, the computing device 100 may determine whether the reliability of the second analysis result 54 is equal to or higher than a threshold. When the reliability of the second analysis result 54 is lower than the threshold, the computing device 100 may determine a cheating behavior, which is the first expected behavior 55, to be the behavior of the test taker. When the reliability of the second analysis result 54 is equal to or higher than the threshold, the computing device 100 may combine the first analysis result 53 and the second analysis result 54 and determine whether the result of the combination is present in a predetermined ruleset. When the computing device 100 determines that the result of the combination is present as a determination condition included in the predetermined ruleset, a cheating or abnormal behavior, which is a behavior based on the determined determination condition, may be determined to be the behavior of the test taker.

The various embodiments of the present disclosure described above may be combined with one or more additional embodiments, and may be changed within the range understandable to those skilled in the art in light of the above detailed description. The embodiments of the present disclosure should be understood as illustrative but not restrictive in all respects. For example, individual components described as unitary may be implemented in a distributed manner, and similarly, the components described as distributed may also be implemented in a combined form. Accordingly, all changes or modifications derived from the meanings and scopes of the claims of the present disclosure and their equivalents should be construed as being included in the scope of the present disclosure.

1. An artificial intelligence-based behavior monitoring method, the artificial intelligence-based behavior monitoring method being performed by a computing device including at least one processor, the artificial intelligence-based behavior monitoring method comprising:
synchronizing first image data captured from a first direction based on a face of a person who is a subject of behavior monitoring and second image data captured from a second direction different from the first direction;
generating an analysis result for at least one detection item included in each of a plurality of detection targets based on each of the synchronized first image data and second image data by using a pre-trained neural network model; and
estimating a behavior of the person by combining a first analysis result based on the synchronized first image data and a second analysis result based on the synchronized second image data.

2. The artificial intelligence-based behavior monitoring method of claim 1, wherein:
the detection item is state information identified based on a subclass of the detection target; and
the state information is changeable according to the behavior of the person.

3. The artificial intelligence-based behavior monitoring method of claim 1, wherein the plurality of detection targets comprise one or more of a body part of the person, a thing excluding the person, a sound of an object associated with the behavior of the person, and a time of an object associated with the behavior of the person.

4. The artificial intelligence-based behavior monitoring method of claim 1, wherein the neural network model comprises:
a first model for tracking a gaze of the person based on image data captured in the first direction; and
a second model for estimating a pose of the person based on image data captured in the second direction.

5. The artificial intelligence-based behavior monitoring method of claim 4, wherein generating the analysis result for at least one detection item included in each of the plurality of detection targets based on each of the synchronized first image data and second image data by using the pre-trained neural network model comprises:
when feature points for the face of the person and feature points for a body of the person extracted by inputting the synchronized second image data to the second model are misaligned with each other by a predetermined angle or more,
correcting the feature points extracted from the synchronized second image data based on a coordinate system of feature points extracted by inputting the synchronized first image data to the first model.

6. The artificial intelligence-based behavior monitoring method of claim 1, wherein determining the determination condition for estimating the behavior of the person by combining the first analysis result based on the synchronized first image data and the second analysis result based on the synchronized second image data comprises:
determining whether a first expected behavior according to the first analysis result and a second expected behavior according to the second analysis result match each other;
estimating a reliability of at least one of the first and second analysis results; and
estimating the behavior of the person by combining the first analysis result and the second analysis result based on the determined presence or absence of a match and the estimated reliability.

7. The artificial intelligence-based behavior monitoring method of claim 6, wherein estimating the behavior of the person by combining the first analysis result and the second analysis result based on the determined presence or absence of the match and the estimated reliability comprises:
when the first expected behavior and the second expected behavior match each other,
estimating the matched expected behavior as the behavior of the person.

8. The artificial intelligence-based behavior monitoring method of claim 6, wherein estimating the behavior of the person by combining the first analysis result and the second analysis result based on the determined presence or absence of the match and the estimated reliability comprises:
when the first expected behavior and the second expected behavior do not match each other and a reliability of the second analysis result is lower than a threshold,
estimating the first expected behavior as the behavior of the person.

9. The artificial intelligence-based behavior monitoring method of claim 6, wherein estimating the behavior of the person by combining the first analysis result and the second analysis result based on the determined presence or absence of the match and the estimated reliability comprises:
when the first expected behavior and the second expected behavior do not match each other and a reliability of the second analysis result is equal to or higher than a threshold,
estimating the behavior of the person based on a determination condition derived by combining the first and second analysis results.

10. The artificial intelligence-based behavior monitoring method of claim 1, wherein:
the first direction is a direction from a front of the face; and
the second direction is a direction from a side of the face.

11. A computer program stored in a computer-readable storage medium, the computer program causing operations for monitoring behavior based on artificial intelligence to be performed when executed by at least one processor, wherein the operations comprise operations of:
synchronizing first image data captured from a first direction based on a face of a person who is a subject of behavior monitoring and second image data captured from a second direction different from the first direction;
generating an analysis result for at least one detection item included in each of a plurality of detection targets based on each of the synchronized first image data and second image data by using a pre-trained neural network model; and
estimating a behavior of the person by combining a first analysis result based on the synchronized first image data and a second analysis result based on the synchronized second image data.

12. A computing device for monitoring behavior based on artificial intelligence, the computing device comprising:
a processor including at least one core;
memory including program codes executable by the processor; and
a network unit for obtaining image data;
wherein the processor:
synchronizes first image data captured from a first direction based on a face of a person who is a subject of behavior monitoring and second image data captured from a second direction different from the first direction;
generates an analysis result for at least one detection item included in each of a plurality of detection targets based on each of the synchronized first image data and second image data by using a pre-trained neural network model; and
estimates a behavior of the person by combining a first analysis result based on the synchronized first image data and a second analysis result based on the synchronized second image data.
